(19) United States
(12) Patent Application Publication
(10) Pub. No.: US 2021/0088334 A1
(43) Pub. Date: Mar. 25, 2021

(54) Survey Pole with Electronic Measurement and Automatic Signal Transmittal

(71) Applicant: Joshua Bembenek, Rogers, AR (US)

(72) Inventor: Joshua Bembenek, Rogers, AR (US)

(21) Appl. No.: 17/024,326

(22) Filed: Sep. 17, 2020

Related U.S. Application Data
(60) Provisional application No. 62/903,000, filed on Sep. 20, 2019.

(51) Int. Cl. G01C 15/06; G01C 15/00

(52) U.S. Cl. CPC G01C 15/06; G01C 15/002

(57) ABSTRACT

A land surveying system for automatically measuring and transmitting caliper adjustment measurements includes a plurality of reflection targets, each having a support member including specific identification information by which the reflection target can be identified from any other reflection target. Each reflection target is length adjustable and includes an electronic caliper operable to measure a length associated with a length adjustment of the reflection target. Each reflection target is Bluetooth equipped and is to automatically transmit the measured length data point (which is received by the data collector (aka data collector). The land survey system may include a survey module (data collector) for determining a distance measurement programmed to transmit a plurality of distance-measuring signals to the plurality of reflection targets and to receive reflected signals in return and to receive the transmitted measured length data point for use with the reflected signals to determine length and angular data.

### REFERENCE TO RELATED APPLICATIONS

This application claims the priority of provisional patent application U.S. Ser. No. 62/903,000 filed Sep. 18, 2019 titled Survey Pole with Electronic Measurement and Automatic Signal Transmittal and which is incorporated in its entirety herein by reference.

### BACKGROUND OF THE INVENTION

This invention relates generally to land surveying devices and, more particularly, to a surveying pole having an adjustable rod whose vertical adjustment is measured automatically and precisely using integrated electronic calipers with the automatic measurement being transmitted, such as via Bluetooth, to a data collector remote from the surveying pole.

Land surveying, which may be referred to simply as surveying, involves dote the terrestrial or three-dimensional positions of points and the distances and angles between them. Surveying instruments are used to make a survey of land prior to beginning development or construction on the chosen tract of land. For instance, instruments are used to survey building foundations, roads, retaining walls, and the like to determine elevations, slopes, angles, and the like—information that will be needed by contractors in order to perform construction of structures according to blueprints or other planning documents. Common instruments used in surveying include leveling devices, height adjustable rods, lasers, and the like.

In traditional surveying practice, a total station (also referred to as a total station theodolite (TST) is an electronic transit device that uses a laser to calculate distances and angles by aiming at a reflective prism positioned atop a pole or rod that reflects the laser back to the total station. Electronics or a computer program in the total station uses the time of the laser traveling to calculate distances. Further, the height of the rod holding the prism is used with the distance calculation as well as a vertical angle to create a triangle so as to calculate the elevation of the point the rod is standing on.

The rod may also be referred to as a prism pole, vertical pole, surveying rod, or the like and is especially used in cooperation with a total station. The rod itself may be telescopic or otherwise height adjustable so that the prism may be positioned for view by the total station. Specifically, objects such as trees, bushes, and the like may avoided as obstructions when the prison is elevated. Proper triangulation and trigonometric calculations require knowing the distance by which the rod may have been extended upwardly from its standard length and this distance may be measured using calipers or even electronically in which case the measurement may be output to a display. In either case, the surveyor usually records this height adjustment manually or inputs it into a computer and, as a result, introduces the potential for human error. Forgetting to record this height adjustment or recording it incorrectly can have dramatic or even devastating effects. For example, a miscalculation of elevation, slope between two points, or the like may result in contractors spending millions of dollars or even building an incorrect (and unsafe) structure—not to mention wasting precious time until the error is discovered.

Therefore, it would be desirable to have a survey rod that includes digital calipers configured to make accurate and automatic measurements of an increase or decrease in a height (i.e. linear length) of the rod. Further, it would be desirable to have a survey rod configured and operable to transmit the rod-height adjustment data to a recording station via a digital wireless signal, such as by the standards for radio signal communication between two electronic devices known as Bluetooth.

### SUMMARY OF THE INVENTION

A land surveying system for automatically taking and transmitting caliper adjustment measurements according to the present invention includes a plurality of reflection targets, each of which is supported by a support member including specific identification information by which the reflection target can be identified from any other reflection target. Each reflection target is length adjustable either manually or via a motorized linkage. Each reflection includes an electronic caliper operable to measure a length data point associated with a length adjustment of the respective reflection target. Each reflection target includes a communications module in data communication with the electronic caliper and operable to automatically transmit the measured length data point (which is received by the survey module (aka data collector).

The land survey system may include a survey module (data collector) for determining a distance measurement programmed to transmit a plurality of distance-measuring signals to the plurality of reflection targets and to receive reflected signals in return from the plurality of reflection targets, respectively, the data collector being operative to receive the transmitted measured length data point for use with the reflected signals to determine length and angular data.

Therefore, a general object of the present invention is to provide a land surveying system having a plurality of reflection targets, each of which includes an electronic caliper tool in communication with the slidable extension portion of the support rod of the reflection target and configured to measure a length adjustment thereof.

Another object of the present invention is to provide a land surveying system, as aforesaid, in which each electronic caliper is associated with a communications module, such as Bluetooth, for automatically transmitting the length adjustment data to a data collector for use in making elevation calculations.

Still another object of the present invention is to provide a land surveying system, as aforesaid, in which the caliper and communications module are integrally part of the construction of the support pole of reflection target.

Yet another object of the present invention is to provide a land surveying system, as aforesaid, in which each reflection target is length adjustable having a base portion and an extension portion selectively slidable in the base portion—whether manually actuated or via a motor and gear combination.

A further object of the present invention is to provide a land surveying system, as aforesaid, having a data collector that is programmed to receive the automatically transmitted length adjustment data from each independently identifiable reflection target.

A still further object of the present invention is to provide a land survey system, as aforesaid, in which the data collector is configured to determine length and elevation data based on reflected rays and the length adjustment data, respectively.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a land surveying system according to a preferred embodiment of the present invention;

FIG. 2a is a perspective view of a motorized adjustable reflection target of the land surveying system of FIG. 1, illustrated in a fully retracted configuration;

FIG. 2b is a perspective view of the reflection target as in FIG. 2a, illustrated in a partially extended configuration;

FIG. 3a is another front perspective view of a motorized reflection target as in FIG. 2a illustrated in a retracted configuration;

FIG. 3b is an isolated view on an enlarged scale taken from FIG. 3a;

FIG. 4a is a rear perspective view of a motorized reflection target according to the present invention, illustrated in a retracted configuration;

FIG. 4b is a rear perspective view of the motorized reflection target as in FIG. 4a, illustrated in an extended configuration;

FIG. 5a is a perspective view of the manually adjustable reflection target as FIG. 2a, illustrated in a retracted configuration with a locking ring for maintaining a set extension;

FIG. 5b is a perspective view of the manually adjustable reflection target as FIG. 2b, illustrated in an extended configuration with a locking ring for maintaining a set extension;

FIG. 6 is a plan view of the land surveying system as in FIG. 1, illustrating signal actuation between the data collector and a remote reflection target with an obstacle in the way;

FIG. 7 is a plan view of the land surveying system as in FIG. 1, illustrating signal actuation between the data collector and a remote reflection target and with an obstacle avoided as the reflection device is extended;

FIG. 8 is a plan view of the land surveying system as in FIG. 7, illustrating a data collector (i.e. the survey machine) transmitting distance measuring signals and receiving the associated reflected signals and also transmission and receipt of a measured data point signal;

FIG. 9 is a block diagram illustrating the electronic components of the data collector (iaka survey machine); and

FIG. 10 is a block diagram illustrating the electronic components of a reflection target.

### DESCRIPTION OF THE PREFERRED EMBODIMENT

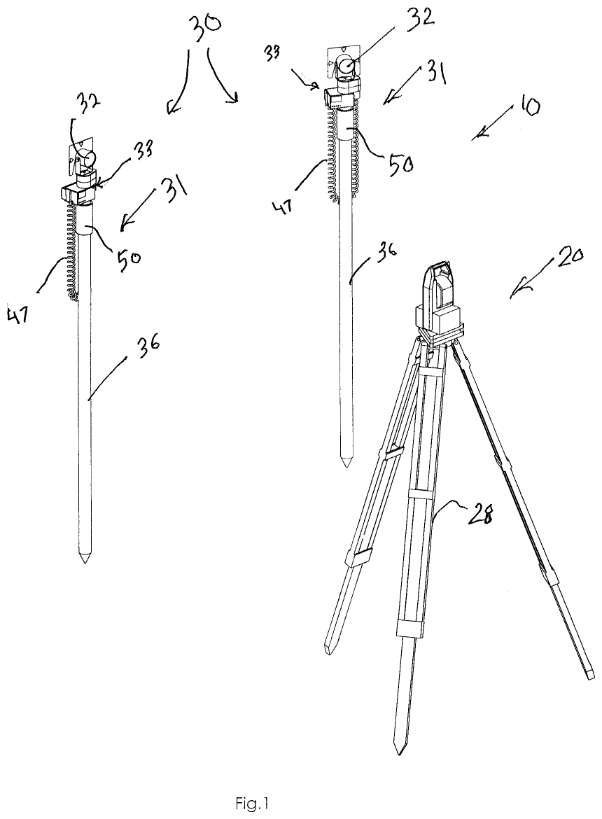

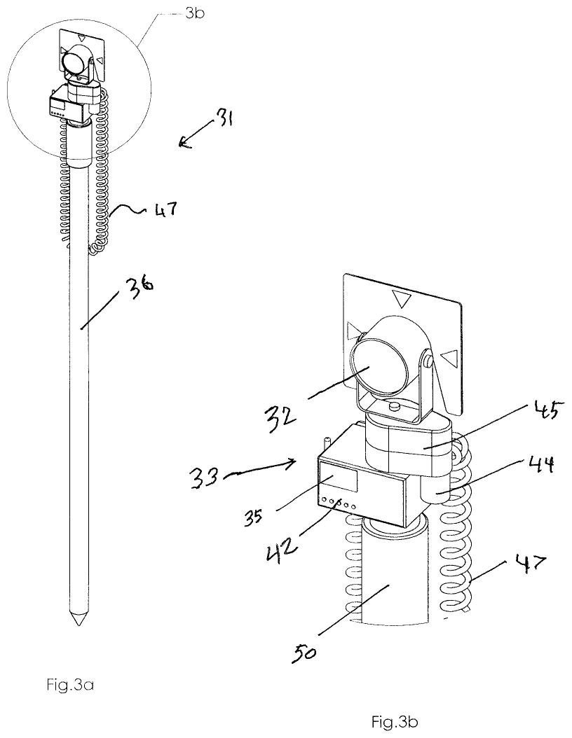

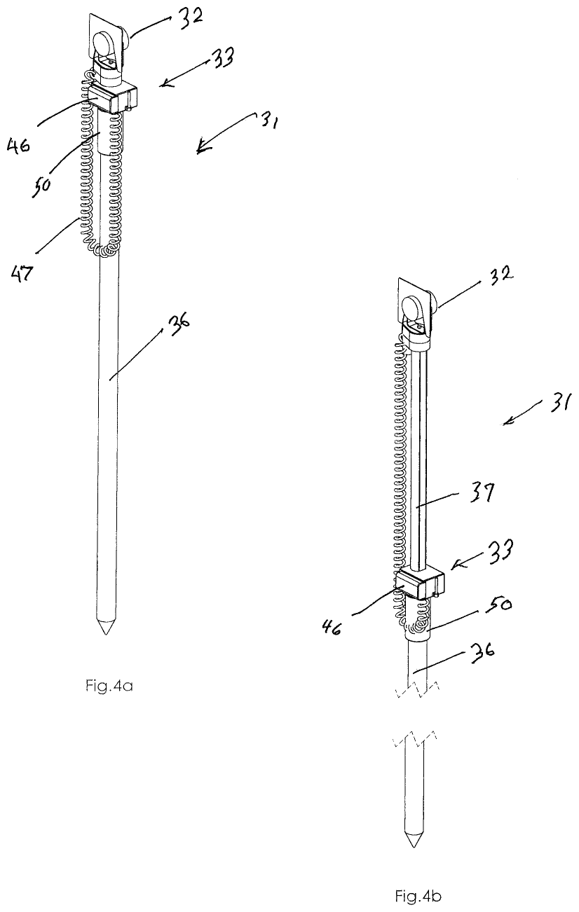

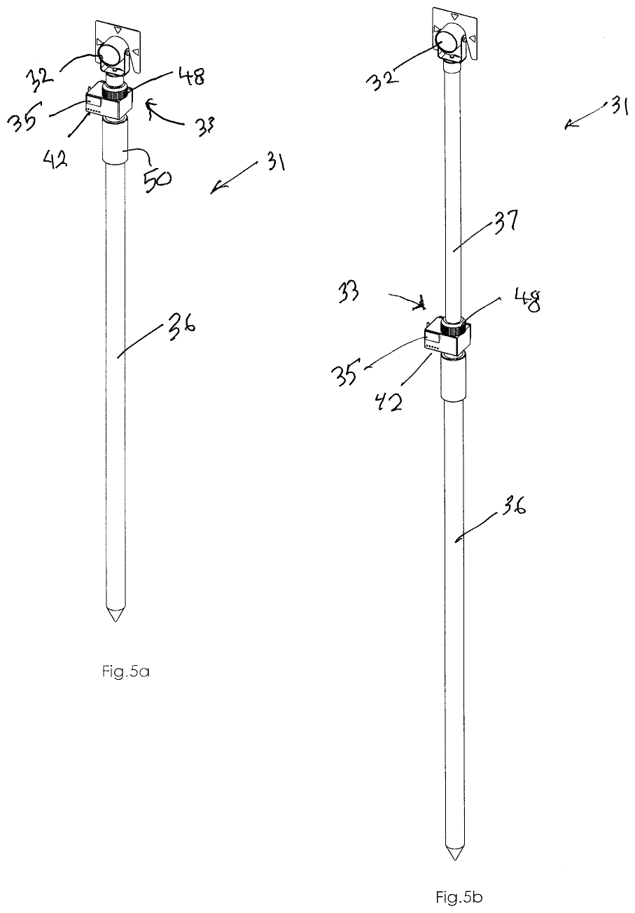

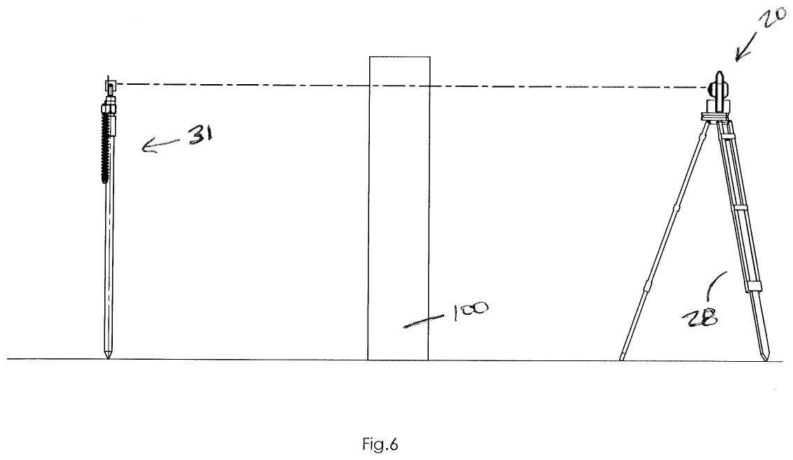

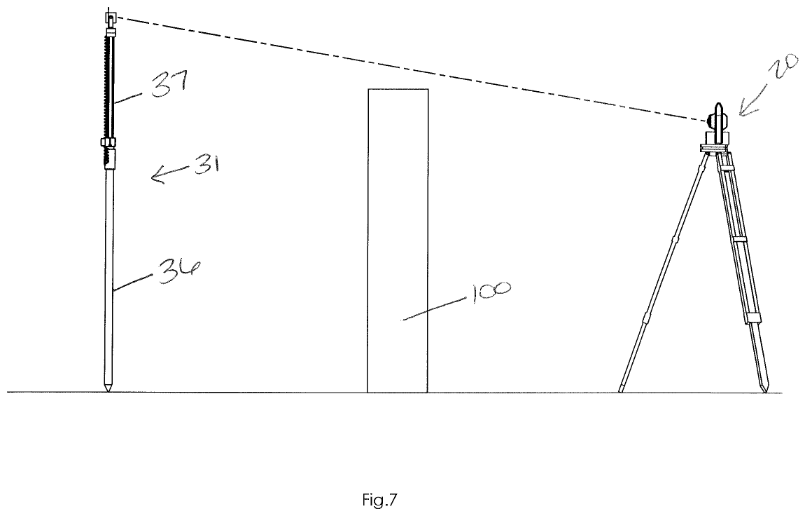

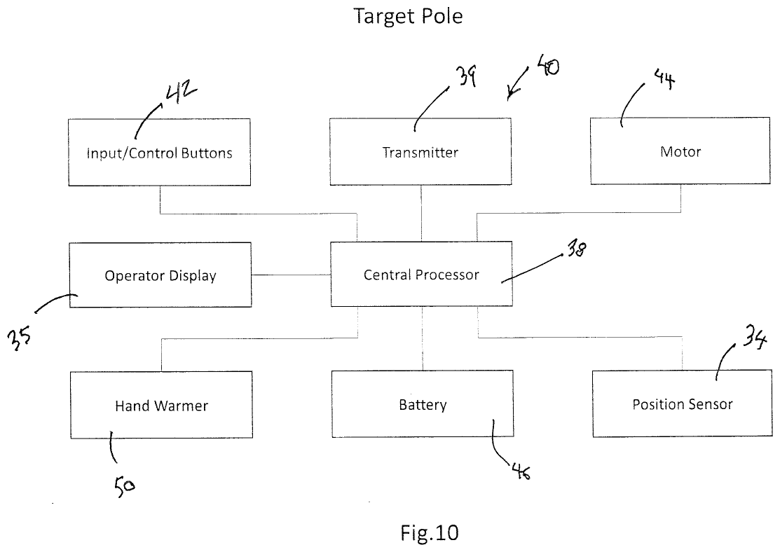

A land surveying system according to a preferred embodiment of the present invention will now be described with reference to FIGS. 1 to 10 of the accompanying drawings. The land surveying system 10 may include a plurality of reflection targets 30 (and, in particular, a single reflection target 31. The land survey system 10 may also include a data collector 20 (also referred to as a survey module).

The land surveying system 10 of the present invention may include several instruments including a data collector 20 (which may also be referred to herein as a survey module as it is often referred to using the same reference numeral 20) and a plurality of reflection targets 30. More specifically, however, attention will be directed to a respective reflection target 31 which will include a support rod that is length adjustable and includes an electronic caliper 33 integrated in its construction and is configured to automatically monitor, measure, and transmit a linear length measurement—which may be received by the data collector 20 that is associated with the respective reflection target 31 that transmitted the length measurement.

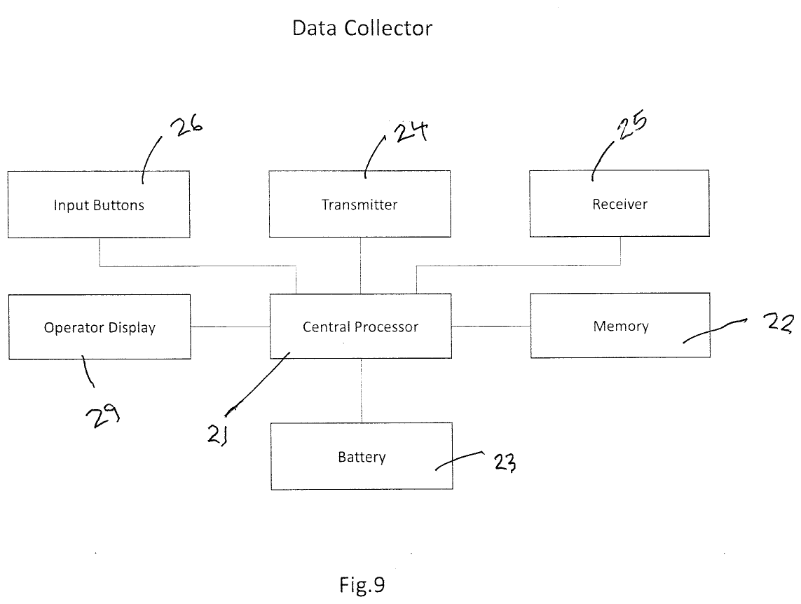

First, the land surveying system 10 may include a survey module 20 (also referred to as a data collector and being reference by the same reference numeral). The survey module 20 is essentially a computer and is operable to actuate signal transmission and reception, and to make various distance calculations that are fundamental and common in land surveying systems know to civil engineers. The land survey module 20 (data collector) may be supported atop a tripod base 28 (FIG. 1). The electronic and electrical components that may be situated in an interior space defined by the housing of the data collector 20 are illustrated in the block diagram of FIG. 9. More particularly, the data collector 20 may include a processor 21 or controller in data communication with a non-volatile memory 22 and electrically connected to a battery 23 as a power source. The memory 22 has data structures configured to store data such as measurement data, angle data, and programming instructions as will be described further later. Further, the processor 21 may be programmed to make the length and angle calculations that will be discussed later. Preferably, the data collector 20 includes GPS electronics (or via a global navigation satellite system (“GNSS”) battery or receiver) to identify its own global position for use in making calculations as described later. In addition, the data collector 20 may include multiple input controls 26 such as buttons, a keypad, touch screen, or the like for actuating the components and actions described herein. Measurement data, user input, and other parameters may be published on a display 29 (FIG. 9).

In an important aspect to the function of surveying, the processor 21 of the data collector 20 is operable to actuate a transmitter 24, which is in data communication with the processor 21, to transmit “reflection signals” (which may also be referred to as a beam of “rays,” “light rays,” like a laser beam or laser light) in the direction of the reflection target 31 (i.e. the support pole), the transmitted signals or beam being intended to shine upon or otherwise impact a reflection surface on the reflection target 31 and be returned to the data collector 20 where the reflected signals are received thereby. The reflection surface is typically referred to as a prism 32, the prism being functionally configured to function like a mirror to reflect the beam of light rays (aka distance measuring signals) back to the data collector 20. Sometimes a survey pole supporting a prism is called a prism pole. Specifically, the data collector 20 may include a receiver 25, also in data communication with the processor 21, configured to receive the reflected signals. The receiver 25 is sometimes referred to as a laser detector. It is understood that the amount of time between the time of transmission and time of reception of the reflected signal is indicative of a distance between the data collector and remote reflection target 31. Of course, any height adjustment of the reflection target 31 (i.e. pole) will affect calculation of length and angle as will be described below. It is understood that the transmitter 24 may also be referred to as an emitter (in the case of use of a laser beam) and the receiver 25 may be referred to as a laser detector.

Reflection targets 30 (i.e. support poles) that are constructed in a manner so as to have an adjustable height, are known in the art. However, when a support pole is raised or lowered (i.e. is length or height adjusted), this change must be manually entered into the data collector 20 so that this new data can be included in the calculations of distance and angle. Unfortunately, the empirical data confirms that this step of manually indicating that the support pole was length adjusted is frequently misreported (out of human error) or forgotten altogether (again, out of human error). Therefore, automatically measuring a length adjustment of a reflection target 31 and then automatically transmitting this length adjustment data to the data collector 20 would be desirable.

Each reflection target 31 includes a support member, such as is illustrated as a pole, it being understood that most reflection targets 30 are in the form of poles. In some embodiments, the reflection target 31 may also be mounted atop a tripod or a pole that is itself mounted atop a tripod support mechanism for additional stability. Each support member of an associated reflection target 31 is length adjustable. The support member in the form of a pole may include a support rod that includes a base portion 36 and an extension portion 37 slidably coupled to said base portion, both of which have a tubular configuration except as specifically discussed later.

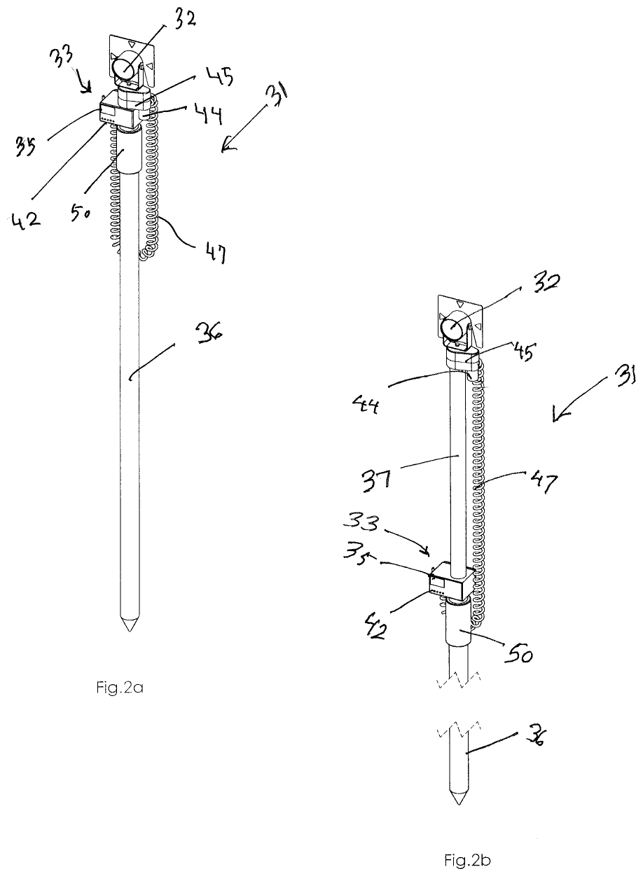

In a manual variation, a user may cause the extension portion 37 to move slidably from a retracted configuration substantially inside the interior space defined by the base portion 36 (FIG. 2a) and an extended configuration partially or fully away from or outside the base portion (FIG. 2b). It is understood that this length adjustment may be needed so that reflected signals (e.g. light rays) may avoid interference from an obstacle 100, such as a tree, bush, wall, or the like. The reflection target 31 and, more particularly, the calipers, includes a position sensor 34 configured and operable to sense the extension described above (FIG. 1). The position sensor 34 generates data that is indicative of a length that the extension portion 37 has been moved. This length adjustment data may be referred to as a length data point and is then sent automatically in the direction of the data collector 20 for use in the distance and angle calculations, which will be described in detail later. It is understood that the position sensor 34 may be a component of the electronic caliper 33.

A critical aspect of the present invention is that each reflection target 31 of the plurality of reflection targets includes an electronic caliper 33 (sometimes referred to as a pair of calipers) integrated in its construction. A caliper is a device used to measure the distance between two opposite sides of an object. Many types of calipers permit reading out a measurement on a ruled scale, a dial, or a digital display. In the present instance, each reflection target 31 may include a digital display 35 that is electrically coupled to or integral to the caliper 33. The readout on the display may be a very exact numerical measurement—accurate to multiple significant digits. It is understood that the caliper 33 may be in data communication, such as with a wire, wireless communication, or a computer chip with the display 35 and a processor 38 or electronic controller and Bluetooth transmitter 39 and, of course, the extension portion 37 so as to measure its movement.

As has been alluded to above, each reflection target 31 includes a communications module 40. Preferably, the communications module 40 includes a Bluetooth transmitter 39 capable of wirelessly transmitting the length adjustment data over a short distance. While Bluetooth is preferred, other wireless short distance platforms may also work, such as near-field communications (NFC), radio frequency identification (RFID), traditional transmitter/receiver radio transmissions or the like.

In a related embodiment, slidable movement of the extension portion 37 relative to the base portion 36 of the support pole of a reflection target 31 is motorized. Preferably, an extension motor 44 and an extension gearbox 45 may be coupled to an upper end of the extension portion 37 of the support device (pole). Although not shown explicitly, it will be understood by one of ordinary skill in the art that the gearbox 45 may include a worm gear, a screw gear, a rack and pinion gear rack, or the like that is configured to incrementally move the extension portion 37 when the motor 44 is energized. In other words, the motor 44 is electrically and mechanically coupled to the gearbox 45 which is mechanically coupled to the extension portion 37. In addition, the electronic caliper 33 and its display 35 may be powered by a battery 46 and this same power source may be electrically connected to the motor 44 and gearbox 45 via a power cord 47. In an embodiment, the battery 46 may be a GPS GNSS receiver battery. GNSS refers to a global navigation satellite system and may include a receiver able to track its own global position. Preferably, the power cord 47 is constructed of an elastic material that may stretch to a sufficient length as the extension portion 37 is raised and that is durable in harsh weather and environmental conditions. Of course, the power cord 47 may be situated inside the extension portion 37 in some embodiments so as to be hidden from exterior view. The reflection target 31 may include one or more input controls 42, such as buttons, dials, keypad, or the like for operating the motor 44, transmission of the adjustment signal, or other actions described herein.

In related aspects, the extension portion 37 of the support pole may include a flattened side that naturally prevents unintended or unwanted rotation relative to the base portion 36 and may also include optical scale data used by the calipers 33 (Fig.). In addition, the support pole or rod may include a locking ring 48 having a self-locking thread configuration operable to lock the extension portion into an adjusted configuration. The locking ring 48 may be situated atop the display 35 of the calipers 33 and defining a void through which the extension portion 37 is allowed to slide. But then, when tightened, the locking ring 48 frictionally prevents the extension portion 37 from moving slidably relative to the base portion 36. In other words, once a length adjustment has been made, whether manually or by operation of the motor 44, the height of a respective reflection target 31 may be locked-in during use. It is understood that the locking ring 48 is only provided in the manually adjustable variation as the gears in the motorized variation will hold an adjustment in place. Further, each reflection target 31 may include identification data that uniquely identifies a respective reflection target 31 from any other reflection target. It will be understood that this identifying information may be transmitted in every transmission between a respective reflection target 31 and the data collector 20 for organization of the various calculations.

In another aspect, each reflection target 31 and, more particularly, the support pole associated therewith, may include a hand warming device 50 (FIG. 2a). The hand warming device 50 is preferably constructed of a conductive material and may be electrically, to the battery 46 as its power source and to the input controls 42 for selective actuation by a user although in some embodiments, an actuator may be positioned on the hand warming device itself (not shown). Preferably the hand warming device 50 has a configuration like a collar or sleeve and is mounted to the support pole downwardly adjacent the caliper 33.

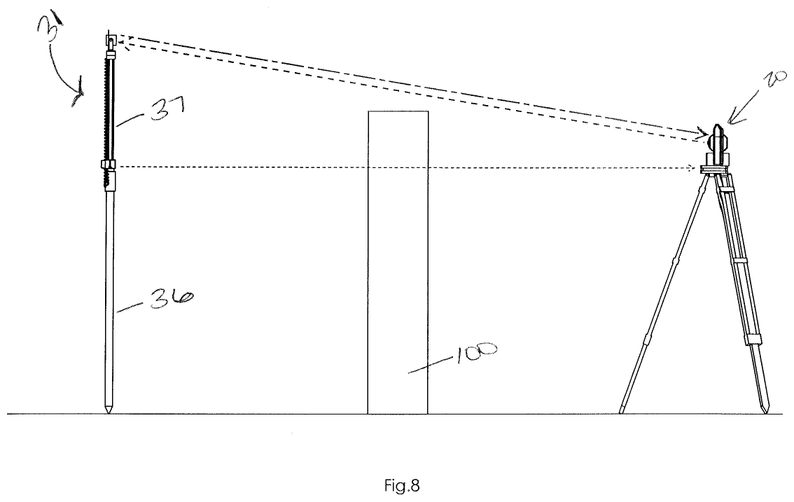

In use, the support pole of a respective reflection target 31 includes an electronic caliper 33 having a position sensor 34 for measuring a length adjustment of the extension portion 37 relative to a stationary base portion 36 of the support rod. The measured length adjustment is then automatically transmitted, such as via Bluetooth, to the associated data collector 20 as shown in FIG. 8 so that reflected light rays and the length adjustment data are used together to calculate length and elevation data for a land survey.

It is understood that while certain forms of this invention have been illustrated and described, it is not limited thereto except insofar as such limitations are included in the following claims and allowable functional equivalents thereof.

1. A land surveying system for automatically taking and transmitting length adjustment measurements, said survey apparatus comprising:
a plurality of reflection targets, each of which is supported by a support member including specific identification information by which the reflection target can be identified from any other reflection target;
wherein said each reflection target is length adjustable;
wherein a respective one of said plurality of reflection targets includes an electronic caliper operable to measure a length data point associated with a length adjustment of said respective reflection target;
wherein said respective reflection target includes a communications module in data communication with said electronic caliper and operable to automatically transmit said measured length data point; and
a data collector for determining a distance measurement is programmed to transmit a plurality of distance-measuring signals to the plurality of reflection targets and to receive reflected signals in return from the plurality of reflection targets, respectively, said data collector being operative to receive said transmitted measured length data point;
wherein said data collector is programmed to use said received measured length data point along with said reflected signals in a calculation to determine said distance measurement.

2. The land surveying system as in claim 1, wherein said data collector is programmed to use said measured length data points along with said reflected signals, received collectively from said plurality of reflection targets, and along with fixed position data associated with said data collector in a calculation to determine distance and angular measurement data relating to a predetermined land area.

3. The land surveying system as in claim 1, wherein said respective reflection target is a support rod that includes a base portion and an extension portion slidably coupled to said base portion, said respective reflection target that includes a prism situated atop said extension portion that is operable to reflect said distance-measuring signals.

4. The land surveying system as in claim 1, wherein said respective reflection target is manually length adjustable.

5. The land surveying system as in claim 3, wherein said respective reflection target includes a motor operatively coupled to said extension portion for motorized length adjustment of said respective reflection target when said motor is actuated.

6. The land surveying system as in claim 1, wherein said communications module of said respective reflection target is a wireless short-range radio signal communications technology.

7. The land surveying system as in claim 6, wherein said communications module includes Bluetooth components.

8. The land surveying system as in claim 3, wherein said electronic caliper is positioned in said support rod and is in data communication with said extension portion and with said communication module.

9. The land surveying system as in claim 1, wherein said data collector comprises:
a processor;
a non-volatile memory in data communication with said processor, said non-volatile memory configured for storage of data and programming;
a communications link in data communication with said processor and said non-volatile memory and including a transmitter configured to emit a plurality of distance-measuring signals and including a receiver configured to receive a plurality of reflected signals and to receive a plurality of measured length data points associated with said plurality of reflection targets.

10. The land surveying system as in claim 1, further comprising a warming device positioned on each support member of said plurality of reflection targets, respectively.

11. A land surveying method for automatically taking and transmitting length adjustment measurements, said land surveying method comprising:
providing:
a plurality of reflection targets, each of which is supported by a support member and includes specific identification information by which the reflection target can be identified from any other reflection target;
wherein said each reflection target is length adjustable.
wherein said each of said plurality of reflection targets includes an electronic caliper integrally mounted therein;
wherein said each reflection target includes a communications module in data communication with said electronic caliper, respectively;
a data collector for determining a distance measurement based on distance-measuring signals which are transmitted to a respective reflection target and reflected signals which are received from said respective reflection target, said data collector being operative to receive said transmitted measured length data point;
said electronic caliper associated with said respective reflection target measuring a length data point associated with a length adjustment of said respective reflection target;
said communication module associated with said respective reflection target automatically transmitting said measured length data point;
said data collector transmitting said distance measuring signals for reflection by said respective reflection target;
said data collector receiving said reflected distance measuring signals;
said data collector receiving said transmitted measured length data point of said respective reflection target;
said data collector determining said distance measurement according to said received measured length data and said received reflected distance measurement signals.

12. The land surveying method as in claim 11, wherein said respective reflection target is a support rod that includes a base portion and an extension portion slidably coupled to said base portion, said respective reflection target that includes a prism situated atop said extension portion that is operable to reflect said distance-measuring signals.

13. The land surveying method as in claim 11, further comprising manually adjusting a length of said respective reflection target.

14. The land surveying method as in claim 12, further comprising adjusting a length of said respective reflection target via a motor operatively connected to said extension portion of said support rod.

15. The land surveying method as in claim 11, wherein said communications module of said respective reflection target is a wireless short-range radio signal communications technology.

16. The land surveying method as in claim 15, wherein said communications module includes Bluetooth components.

17. The land surveying method as in claim 12, wherein said electronic caliper is positioned in said support rod and is in data communication with said extension portion and with said communication module.

18. The land surveying method as in claim 11, wherein said data collector comprises:
a processor;
a non-volatile memory in data communication with said processor, said non-volatile memory configured for storage of data and programming;
a communications link in data communication with said processor and said non-volatile memory and including a transmitter configured to emit a plurality of distance-measuring signals and including a receiver configured to receive a plurality of reflected signals and to receive a plurality of measured length data points associated with said plurality of reflection targets.

19. The land surveying method as in claim 11, further comprising providing a warming device positioned on each support member of said plurality of reflection targets, respectively.

20. The land surveying method as in claim 11, further comprising providing a gear assembly operatively connecting said motor to said extension portion and operatively adjusting the length of the extension portion when said motor is energized.

21. A land surveying system for automatically taking and transmitting length adjustment measurements, said survey apparatus comprising:
a plurality of reflection targets, each of which is supported by a support member including specific identification information by which the reflection target can be identified from any other reflection target;
wherein said each reflection target is length adjustable.
wherein a respective one of said plurality of reflection targets includes an electronic caliper operable to measure a length data point associated with a length adjustment of said respective reflection target;
wherein said respective reflection target includes a communications module in data communication with said electronic caliper and operable to automatically transmit said measured length data point.

22. The land surveying system as in claim 21, further comprising:
a data collector for determining a distance measurement is programmed to transmit a plurality of distance-measuring signals to the plurality of reflection targets and to receive reflected signals in return from the plurality of reflection targets, respectively, said data collector being operative to receive said transmitted measured length data point;
wherein said data collector is programmed to use said received measured length data point along with said reflected signals in a calculation to determine said distance measurement.

23. The land surveying system as in claim 21, wherein said respective reflection target is a support rod that includes a base portion and an extension portion slidably coupled to said base portion, said respective reflection target that includes a prism situated atop said extension portion that is operable to reflect said distance-measuring signals.

24. The land surveying system as in claim 23, wherein said respective reflection target is manually length adjustable.

25. The land surveying system as in claim 23, wherein said respective reflection target includes a motor operatively coupled to said extension portion for motorized length adjustment of said respective reflection target when said motor is actuated.

26. The land surveying system as in claim 21, wherein said communications module of said respective reflection target is a wireless short-range radio signal communications technology.

27. The land surveying system as in claim 26, wherein said communications module includes a Bluetooth transmitter.

28. The land surveying system as in claim 23, wherein said electronic caliper is positioned in said support rod and is in data communication with said extension portion and with said communication module.
